(19) United States
(12) Patent Application Publication
(10) Pub. No.: US 2004/0107920 A1
(43) Pub. Date: Jun. 10, 2004

(54) Circular action control twitch

(76) Inventors: Lauren L. Thomas, Gilbert, AZ (US); Robert B. Gavin, The Woodlands, TX (US)

Correspondence Address: Mr. Robert B. Gavin, P.O. Box 131330, The Woodlands, TX, 77393-1330, US

(21) Appl. No.: 10/353,870

(22) Filed: May 12, 2003

Related U.S. Application Data
(60) Provisional application No. 60/353,335, filed on Feb. 4, 2002.

(51) Int. Cl. A01K 15/04

(52) U.S. Cl. 119/802

(57) ABSTRACT

A Circular Action Control Twitch is made up of two parts, for restraining and controlling an animal while performing chores or operations such as grooming, examining, holding or administering medical services. The two parts are a solid stainless steel ring and a flexible loop. This simple construction allows for the flexible loop to be twisted around an animals lip or muzzle by rotating or twirling the solid stainless steel ring in a circular motion, any number of degrees. This allows for the Circular Action Control Twitch to be used by a single person with more control of the operation and more control of the pressure exerted to the animals lip. The solid stainless steel ring can then be snapped to the underside of the animals halter for a hands free operation. The Circular Action Control Twitch can be used on any size animal.

### BACKGROUND

This invention is related to an equine twitch and other restraining devices, for controlling an animals behavior. A twitch is used to control the behavior of an animal while performing specific functions beneficial to the animal or its owner. Typically when shoeing, grooming, examining, training or administering medical treatment to an animal, it is sometimes necessary that the animal remain motionless or nearly motionless, for the safety of the animal or the person performing the function. This is generally achieved by applying pressure to an animals muzzle, by looping and tightening a flexible cord around it.

Twitches and other restraining devices (U.S. Pat. No. 147,920, U.S. Pat. No. 1,073,226, U.S. Pat. No. 1,166,708 and U.S. Pat. No. 4,506,472) have been used for many years on animals. One type of twitch utilizes a paddle handle (U.S. Pat. No. 147,920). Another uses a stick handle (U.S. Pat. No. 634,364). Other twitches utilize either a tube handle, pipe handle or grip handle (U.S. Pat. No. 1,883,598, U.S. Pat. No. 4,252,085, U.S. Pat. No. 5,088,449 and U.S. Pat. No. 6,098,572) that incorporates a mechanism to flex or tighten the flexible cord.

The object of this invention is to introduce the Circular Action Control Twitch, a better twitch, and show how it has unique features;

This twitch is the only one that has a solid stainless steel ring for a handle.

This twitch is the only one that utilizes a solid stainless steel ring for tightening a cord on an animals lip.

This twitch is the only one that can be snapped back to the animals halter allowing for a hands free operation.

This twitch is the only one that can apply increasing and decreasing pressure to the animal, by rotating a single hand any number of degrees, in a circular motion.

### SUMMARY OF THE INVENTION

The Circular Action Control Twitch is used to control the behavior of an animal while performing specific functions beneficial to the animal or its owner. Typically when grooming, examining, training or administering medical treatment to an animal, it is necessary that the animal remain motionless or nearly motionless, for the safety of the animal or the person performing the function. A solid steel ring is rotated in a circular motion to tighten or loosen, a flexible loop around an animal's lip. The Circular Action Control Twitch applies a soft, even, steady and humane pressure to the animals lip while the operation is being performed. The solid steel ring can then be snapped to the underside of the animals halter for a hands free operation. The Circular Action Control Twitch can be used on any size animal.

### BRIEF DESCRIPTION OF DRAWINGS

FIG. 1 is a front view of a Stainless Steel Ring forming the hard loop of the Circular Action Control Twitch, also shown is a cross sectional diagram of the 3/16 inch diameter round stock.

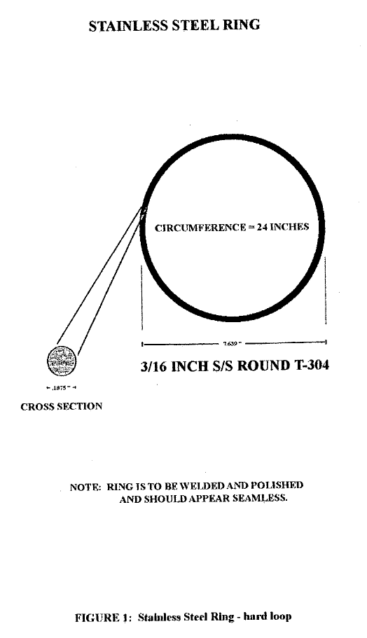

FIG. 2 is a view of an 18 inch length of 1/4 inch diameter braided rope which has been chosen to be used as the flexible loop of the Circular Action Control Twitch.

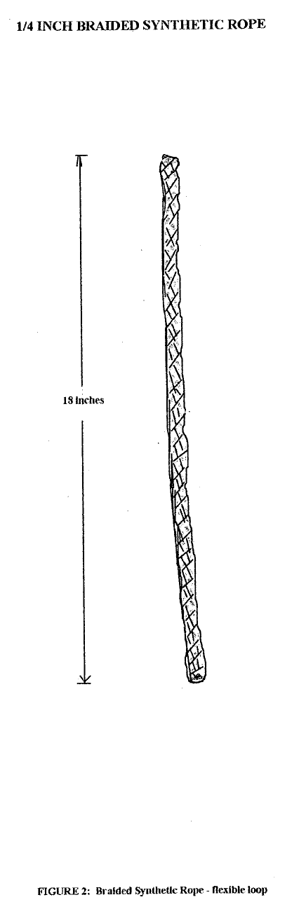

FIG. 3 is a front view of the finished invention, a Circular Action Control Twitch.

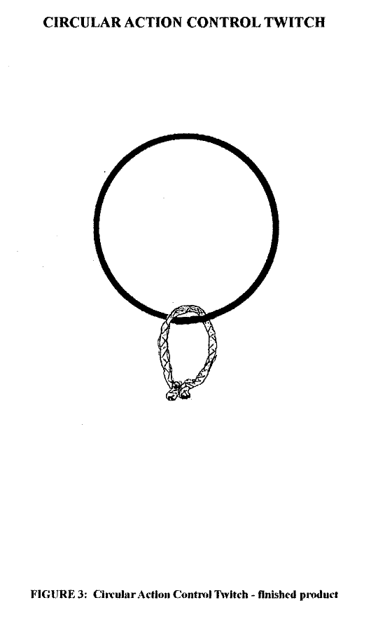

### DETAILED DESCRIPTION OF THE INVENTION

The Circular Action Control Twitch is related to an animal twitch and is composed of two main components. The first component is a Stainless Steel Ring referred herein this detailed description as the “hard loop”. The other component is a short length of rope, cord, strip of plastic, leather strip, light chain, rubber tubing or other material that is flexible, herein referred to as the “flexible loop”.

The “hard loop” is fabricated from 3/16 inch diameter, T-304 grade stainless steel round stock. The round stock is cut into 24 inch lengths and then bent into a circle, end to end. The ends are welded and polished to appear seamless, forming a solid stainless steel ring (see FIG. #1).

The “flexible loop” is fabricated from rope, cord, strip of plastic, leather strip, light chain, rubber tubing or other material, ¼-1/2 inch in diameter, The “flexible loop” material is cut into 18 inch lengths and fastened by knot or other fastening device, end to end (see FIG. #2).

The basis for the Circular Action Control Twitch as a finished product, is the fact that the “flexible loop” is tied or fastened to the “hard loop”, in a fashion that the two are intertwined (see FIG. #3).

To operate the Circular Action Control Twitch; first, slip one hand through the “flexible loop”. Next, grasp the animals muzzle and slip “flexible loop” over the animals lip. Following, put opposite hand through the “hard loop” to the wrist. By twirling the hand which is through the “hard loop” in a circular motion, to rotate the “flexible loop” is tightened around the animals lip. Finally, user has the option to snap hard loop back to the animals halter for a hands free operation, or hold the hard loop to adjust pressure as needed.

What I claim is:

1) A Circular Action Control Twitch is the only one that has a solid stainless steel ring for a handle.

2) This Circular Action Control Twitch of claim 1 is the only one that utilizes a solid stainless steel ring for tightening a flexible loop on an animals lip.

3) This Circular Action Control Twitch of claim 1 is the only one that can be snapped back to the animals halter allowing for a hands free operation.

4) This Circular Action Control Twitch of claim 1 is the only one that can apply increasing or decreasing pressure to the animal, by rotating it with a single hand, any number of degrees, in a circular action.
